(19) United States
(12) Patent Application Publication
(10) Pub. No.: US 2015/0170148 A1
(43) Pub. Date: Jun. 18, 2015

(54) REAL-TIME TRANSACTION VALIDITY VERIFICATION USING BEHAVIORAL AND TRANSACTIONAL METADATA

(71) Applicant: Seth Priebatsch, Boston, MA (US)

(72) Inventor: Seth Priebatsch, Boston, MA (US)

(21) Appl. No.: 14/107,677

(22) Filed: Dec. 16, 2013

(51) Int. Cl. G06Q 20/40

(52) U.S. Cl. CPC G06Q 20/4016

(57) ABSTRACT

Representative embodiments of a method of verifying a payment authorization to complete a current transaction include, at a server, receiving, from a merchant device, a consumer-originated request for processing the payment to complete the current transaction; matching received information in the request to records associated with the consumer, thereby identifying the consumer who originated the processing request; retrieving historical transactional and non-transactional data in records associated with the identified consumer; computationally determining consistency between the received information in the current transaction and the retrieved transactional and non-transactional data; and based on the determined consistency, determining a likelihood that the current transaction has been validly initiated by the consumer.

### FIELD OF THE INVENTION

In various embodiments, the present invention relates generally to systems and methods for verifying the validity of payment transactions.

### BACKGROUND

It is common practice for consumers to pay a merchant electronically for goods or services received. Electronic payments are typically made with a token that identifies a source of funding. For example, a credit card containing a magnetic strip is a token. Payment tokens usually contain static information, such as an account number, identifying a source of payment. When a credit card is swiped, the card number is transmitted to a centralized payment-processing system. Before authorizing payment, the centralized payment-processing system may verify whether the account exists and is active, whether the account can fund the transaction, or whether the transaction may be fraudulent. A physical token such as a credit card cannot be easily modified and, in the event that it is lost or stolen, the consumer must report the lost card and wait for a replacement to be mailed. As a result, systems that allow a consumer to pay for a transaction at the point of sale (POS), using a mobile device to display a token (usually in the form of a barcode or QR code), are becoming widely accepted. Similar to credit-card tokens, mobile device tokens typically contain static information that must be transmitted to a centralized payment-processing system for authentication and payment authorization.

Mobile devices, however, are highly susceptible to loss or theft; a third party may use the payment tokens stored in a mobile device to place unauthorized orders or make unauthorized purchases. In addition, mobile device provisioning and software systems are vulnerable to malicious “hackers,” who circumvent security measures and steal payment credentials. Such violations may discourage users from signing up for mobile payment procedures and therefore limit the adoption of mobile devices as payment vehicles due to security concerns.

The size and convenience of today's mobile devices also make them easy to lose, and their value makes them an attractive target for thieves. Methods for securing sensitive credential and payment data stored on a mobile device have been developed, but these can be complicated and degrade the user convenience that makes mobile devices so attractive. They can also be spoofed by an experience hacker. Consequently, there is a need for a more conveniently implemented and utilized approach that can detect unauthorized use of the mobile device tokens and/or payment data encrypted therein, thereby timely interrupting or denying an attempted fraudulent transaction made using the mobile device.

### SUMMARY

In various embodiments, the present invention automatically and reliably verifies the validity of a transaction and detects fraudulent mobile transactions in near real-time using transactional and non-transactional information about the consumer. Transactional data may be drawn from the consumer's records with a payment entity, while non-transactional data may arise from any of various sources—e.g., social media, preference information provided to or inferred by a merchant or a payment entity, or public or private databases. Non-transactional data, while nominally unrelated to purchasing activity, may nonetheless bear on the likelihood that a purchase is legitimately attributable to a particular consumer: a member of a vegan organization, for example, is unlikely to purchase meat. If the requested transaction contains information consistent with (or at least not inconsistent with) the transactional and non-transactional data associated with the consumer, the transaction is determined to be likely valid. If, however, the information in the requested transaction conflicts with the associated transactional and non-transactional data, the transaction is determined to be likely fraudulent; the transaction may then be interrupted to prevent unauthorized payment. The consumer's records may be stored in a storage device associated with the identity-management server or in a media application server that hosts social media applications and/or stores or has real-time access to the consumer's transactional and non-transactional data.

Accordingly, in one aspect, the invention pertains to a method of verifying a payment authorization to complete a current transaction between a consumer and a merchant. In various embodiments, the method includes, at a server, receiving, from a merchant device, a consumer-originated request for processing the payment to complete the current transaction; matching received information in the request to records associated with the consumer, thereby identifying the consumer who originated the processing request; retrieving historical transactional and non-transactional data in records associated with the identified consumer; computationally determining consistency between the received information in the current transaction and the retrieved transactional and non-transactional data; and based on the determined consistency, determining a likelihood that the current transaction has been validly initiated by the consumer and processing the transaction if the likelihood exceeds a threshold. In one implementation, the consistency-determining step includes applying one or more analysis rules to the transactional data and/or non-transactional data. The analysis rule(s) assign one or more risk scores to the current transaction.

The method may further include (i) classifying the transactional and non-transactional data into multiple classes; (ii) classifying data in the current transaction into one or more classes; and (iii) based at least in part on the analysis rule(s), determining consistency between the class(es) of data in the current transaction and the historical data within the multiple classes of the transactional and non-transactional data. In various embodiments, the transactional classes include (a) type of goods, (b) type of service, and (c) dates and time of purchase; each transactional class is typically associated with one or more analysis rules. Additionally, the analysis rule(s) may specify (a) pairings of goods or services purchased together in a single transaction, (b) the maximum price previously paid by the consumer for a type of goods or services, (c) the minimum price previously paid by the consumer for a type of goods or services, and/or (d) the duration between successive purchases of items of the same type. The non-transactional classes may include (a) preference data, (b) current interaction with a social-media site, (c) the current GPS location, and (d) current weather conditions; each non-transactional class is typically associated with one or more analysis rule(s). The analysis rule(s) may specify (a) consistency between a consumer preference and items purchased in the current transaction, (b) consistency between current interaction with a social-media site and the current transaction, (c) consistency between the current GPS location and the current transaction, and/or (d) consistency between current weather conditions and the current transaction.

In various embodiments, the method includes (i) acquiring, from the second server upon receiving the consumer-originated request, additional records associated with the identified consumer; and (ii) determining consistency between the additional records and data in the current transaction. The additional records are used to generate one or more new analysis rules and/or modify the analysis rule(s).

In one embodiment, at least some of the transactional or non-transactional data is derived from a social media account of the consumer. In addition, the method may include transmitting the processing request to a payment server if the current transaction is determined to be likely valid. If, however, the current transaction is determined to be likely invalid, the method may include interrupting the processing request and requesting additional verification information from the consumer.

In another aspect, the invention relates to a server for a payment authorization to complete a current transaction between a consumer and a merchant. In various embodiments, the server includes a memory containing a database for storing records associated with the consumer; a communication module; and a processor configured to receive, from a merchant device, a consumer-originated request for processing the payment to complete the current transaction; match received information in the request to the records associated with the consumer, thereby identifying the consumer who originated the processing request; retrieve historical transactional and non-transactional data in records associated with the identified consumer; computationally determine consistency between the received information in the current transaction and the retrieved transactional and non-transactional data; and based on the determined consistency, determine a likelihood that the current transaction has been validly initiated by the consumer and process the transaction if the likelihood exceeds a threshold. In one implementation, the processor is configured to computationally determine consistency by applying one or more analysis rules to the transactional data and/or non-transactional data. The analysis rule(s) may assign one or more risk scores to the current transaction.

The server may be further configured to (i) classify the transactional and non-transactional data into multiple classes; (ii) classify data in the current transaction into one or more classes; and (iii) based at least in part on the analysis rule(s), determine consistency between the class(es) of data in the current transaction and the historical data within the multiple classes of the transactional and non-transactional data. In various embodiments, the transactional classes include (a) type of goods, (b) type of service, and (c) dates and time of purchase; each transactional class is associated with one or more analysis rules. Additionally, the analysis rule(s) may specify (a) pairings of goods or services purchased together in a single transaction, (b) the maximum price previously paid by the consumer for a type of goods or services, (c) the minimum price previously paid by the consumer for a type of goods or services, and/or (d) the duration between successive purchases of items of the same type. The non-transactional classes may include (a) preference data, (b) current interaction with a social-media site, (c) the current GPS location, and (d) current weather conditions; each non-transactional class may be associated with one or more analysis rule(s). The analysis rule(s) may specify (a) consistency between a consumer preference and items purchased in the current transaction, (b) consistency between current interaction with a social-media site and the current transaction, (c) consistency between a current GPS location and the current transaction, and/or (d) consistency between current weather conditions and the current transaction.

In various embodiments, the processor is configured to (i) acquire, from the second server upon receiving the consumer-originated request, additional records associated with the identified consumer; and (ii) determine consistency between the additional records and data in the current transaction. The additional records are then used to generate one or more new analysis rules and/or modify the analysis rule(s).

In one embodiment, at least some of the transactional or non-transactional data is derived from a social media account of the consumer. In addition, the processor may be further configured to transmit the processing request to a payment server if the current transaction is determined to be likely valid. If, however, the current transaction is determined to be likely invalid, the processor may be further configured to interrupt the processing request and request additional verification information from the consumer.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a block diagram of an exemplary network in accordance with an embodiment of the invention;

FIGS. 2A and 2B are block diagrams of an exemplary mobile device and identity-management server, respectively, in accordance with an embodiment of the invention;

FIG. 3 is a block diagram illustrating the relationship between an example identity-management server and a media application server in accordance with an embodiment of the invention; and

FIG. 4 is a workflow diagram illustrating validity verification of payment transactions in accordance with an embodiment of the invention.

### DETAILED DESCRIPTION

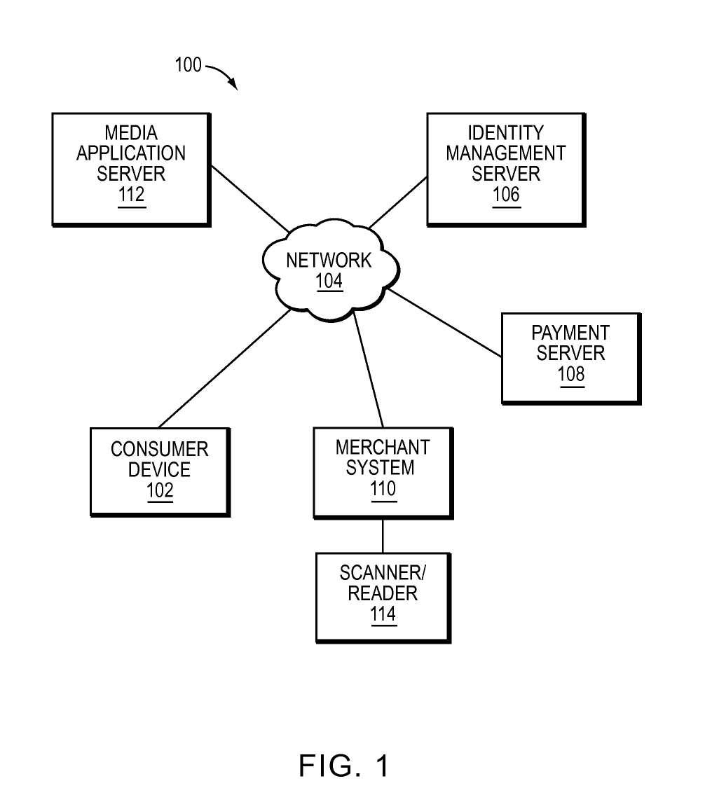

Refer first to FIG. 1, which depicts a mobile-payment transaction network 100 including a consumer device (e.g., a mobile device) 102 linked to other systems via a network 104 that supports wired, wireless, or any two-way communication (e.g., a cellular telephone network, the Internet, or any wide-area network or combination of networks capable of supporting point-to-point data transfer and communication). The network 104 connects various devices, including an identity-management server 106, a payment processor 108, one or more merchant systems 110, and one or more media application servers 112 hosting social media applications and/or storing non-transactional data (such as a membership status) associated with the consumer and utilizing, again, wired, wireless, or any suitable form of two-way communication. Each merchant system 110 may be associated with a merchant who offers goods or services for sale to the consumer device 102. In one embodiment, the merchant system 110 is a point-of-sale (POS) system (e.g., an electronic cash register) that connects to a code reader or scanner (hereafter “reader”) 114. The reader 114 may be mobile or physically associated with the merchant system 110 and may be capable of reading and/or decoding a payment token presented as, for example, a barcode, a radiofrequency identification (RFID) code, or a “Quick Response” (QR) code, and/or receiving signals, such as NFC signals, audio signals, or infrared signals transmitted from the consumer's device 102. The merchant system 110 transmits the received payment token and transaction details to the identity-management server 106 to verify the consumer's identity and determine validity of the transaction as further described below. If the transaction is likely to be valid, the identity-management server 106 may direct the payment request to the payment processor 108 for approval or, in some embodiments, grant the payment request. If the transaction is likely to be invalid, the identity-management server 106 may interrupt the transaction and transmit a denial message to the merchant system 110. The payment processor 108 may be responsible for actually performing the payment transaction and, in some cases, for decrypting the payment token. For example, a so-called “direct” payment processor represents the financial-processing backend provider to credit-card issuers and payment services such as PAYPAL. An “indirect” payment processor is an independent entity processing transactions for multiple payment services and maintains its own records and data.

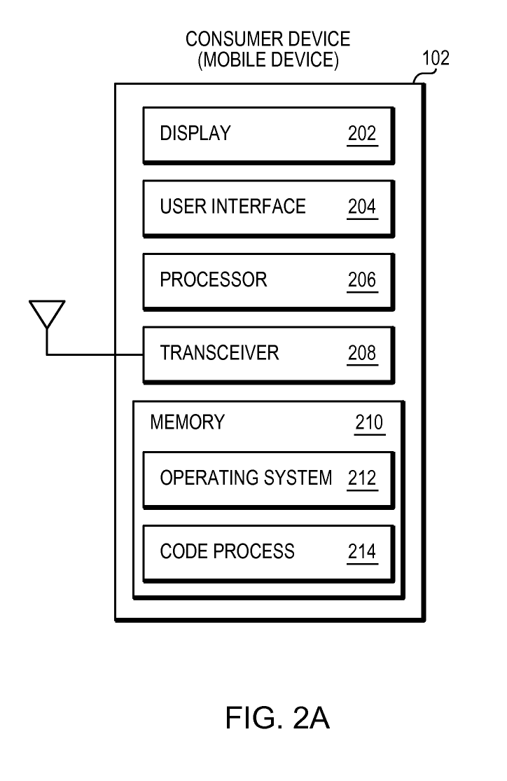

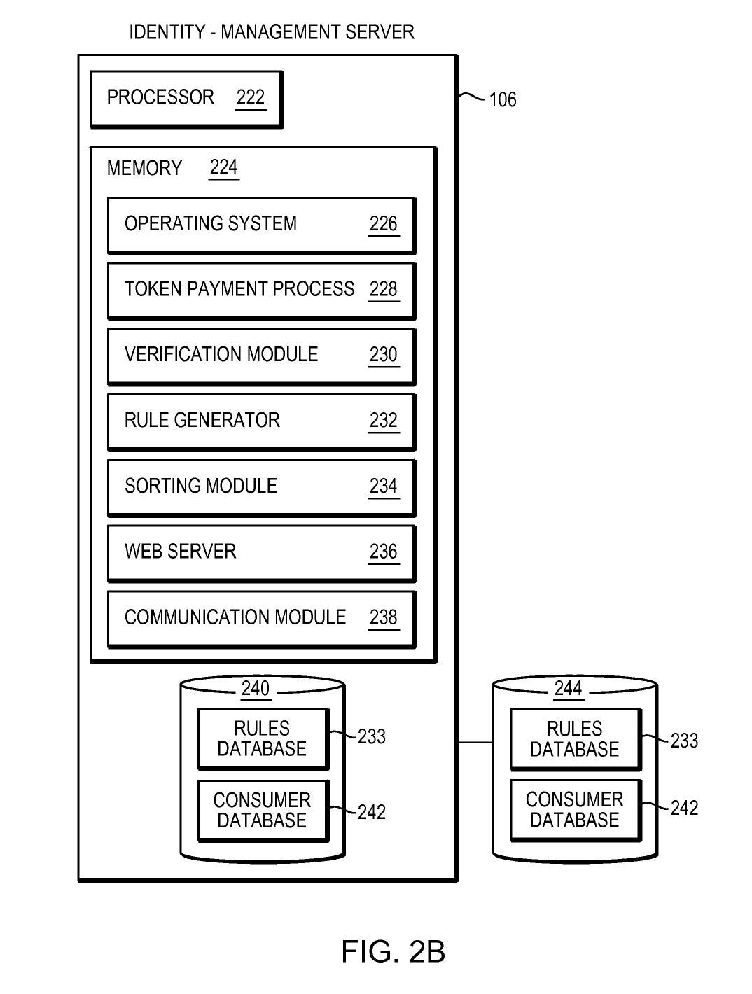

The mobile device 102 acts as a gateway for transmitting the consumer's data (e.g., the payment token) to the network 104. The mobile device 102 can support multiple communication channels for exchanging multimedia and other data with the identity-management and payment server 106 and other devices using a Wi-Fi LAN (e.g., IEEE 802.11 standard) for Internet access, a short-range Bluetooth wireless connection for point-to-point access, and/or an NFC channel for close-proximity access. Referring to FIG. 2A, in various embodiments, the mobile device 102 includes a conventional display screen 202, a user interface 204, a processor 206, a transceiver 208, and a memory 210. The transceiver 208 may be a conventional component (e.g., a network interface or transceiver) designed to provide communications with a network, such as the Internet and/or any other land-based or wireless telecommunications network or system, and, through the network, with the identity-management server 106. The memory 210 includes an operating system (OS) 212, such as GOOGLE ANDROID, NOKIA SYMBIAN, BLACKBERRY RIM or MICROSOFT WINDOWS MOBILE, and a token process 214 that implements the device-side functions for transmitting, receiving and/or generating the payment token. Additional transactional information may be embedded in the token process 214 for transmission through the network 104 for later processing on a back-end server (e.g., the identity-management server 106). As used herein, the term “mobile device” used for transacting a mobile payment refers to a “smart phone” or tablet with advanced computing ability that, generally, facilitates bi-directional communication and data transfer using a mobile telecommunication network, and is capable of executing locally stored applications and/or payment transactions. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs). The memory 210 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit.

Referring to FIG. 2B, in some embodiments, the identity-management server 106 includes a processor 222, a memory 224 having an operating system (OS) 226, a token payment process 228, a verification module 230, a rule generator 232, a rule database 233, a sorting module 234, a web-server block 236, a communication module 238 and a storage device 240. The token payment process 228 implements the server-side functions of transmitting, receiving and/or generating the payment token. Approaches for generating a secure payment token are described in, for example, U.S. Ser. No. 13/718,466, filed on Dec. 18, 2012, and Ser. No. 13/960,260, filed on Aug. 6, 2013, the entire disclosures of which are hereby incorporated by reference.

The verification module 230 determines the likelihood that the requested transaction is valid based on analysis rules created by the rule generator 232 in a “bottom up” fashion or manually in a “top down” fashion, and stored in the rule database 233. In some embodiments, the analysis rules are created by analyzing a consumer's profile and records, containing transactional and/or non-transactional data, stored in a consumer database 242 that resides in the storage device 240 and/or an external mass-storage device 244 accessible to the identity-management server 106 as further described below. Ultimately, the analysis rules may be applied to this same data in determining the legitimacy of a transaction, as described below.

In addition, the analysis rules may be defined by the consumer's information collected from the media application servers 112. During a transaction, the verification module 230 assesses transaction validity by applying all or a relevant subset of the analysis rules to the consumer and/or the requested transaction, and determining the degree to which the requested transaction satisfies the rules. In one embodiment, the sorting module 234 classifies the consumer's records, including transactional and/or non-transactional data, into multiple classes prior to a transaction to facilitate analysis. During a transaction, the sorting module 234 assigns data relating to the transaction to one or more classes. Consistency between the current transactional information and the consumer's records is then assessed by the verification module 230 on a class-by-class basis to simplify analysis. Different classes may be weighted differently, depending on their perceived value in determining the validity of the transaction as further described below.

In addition, the sorting module 234 may group consumers based on information stored in the database 242 and/or collected from the media application servers 112; the categories utilized by the sorting module 234 correspond to factors likely to reveal transaction fraud, and these may be supplied by the system's user a priori or may instead be dynamically identified as the system is used based on, e.g., regression analysis of transactions determined to be fraudulent. The verification module 234 determines the likelihood that the requested transaction is valid based on the records associated with the consumers in each group. The web-server block 236 enables web-based communication with the mobile device 102, the payment processor 108, and the media application servers 112, and can be a conventional web-server application executed by the processor 222. Additionally, the web-server block 236 may interact with any of a variety of public application programming interfaces (or APIs) provided by the media application servers 112; via these APIs, third-party applications collect data available from the media application servers 112 in order to retrieve relevant data about the consumer's profile or records registered in, for example, social media accounts. The communication module 238 may be a conventional component (e.g., a network interface or transceiver) designed to provide communications with a network, such as the Internet and/or any other land-based or wireless telecommunications network or system, and, through the network, with the mobile device 102. The database 242 and/or the media application servers 112 are responsive to queries from the verification module 230, the rule generator 232, and the sorting module 234.

In various embodiments, prior to a transaction, the rule generator 232 may create analysis rules based on a record associated with each consumer “known” to the identity-manager server 106. The record may be stored in the consumer database 242 and/or collected from the media application servers 112 using the web-server block 230 or communication module 238. The record may include, for example, data identifying the consumer's mobile device 102, and the customer's transactional and non-transactional data. The media application servers 112 may host or communicate with social media applications and/or store the consumer's non-transactional data (e.g., membership status and preferences) as well as, in some cases, transactional data (e.g., a previous transaction conducted via a link on the social media application). The media application servers 112 may include or communicate with collaborative projects (e.g., WIKIPEDIA), blogs or microblogs (e.g., TWITTER and PINTEREST), content communities (e.g., YOUTUBE), social networking sites (e.g., FACEBOOK and GOOGLE+), online newspapers, event calendars, message boards, or any one, or combination of, network-based applications utilized by the consumer and which provide useful consumer-specific information for analysis as described below. These hosted activities are generically referred to as media applications.

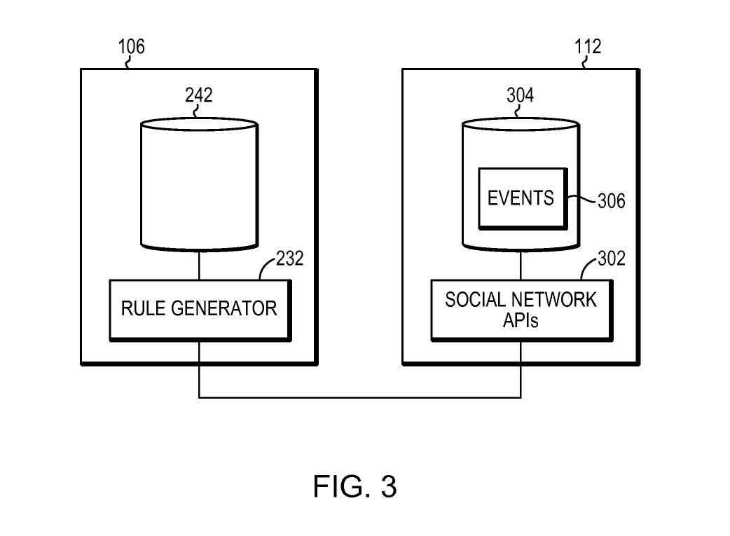

The transactional and/or non-transactional data stored on the media application servers 112 may be accessed or retrieved in various ways. For example, referring to FIG. 3, the identity-management server 106 may interact with the APIs 302 provided by the media application server 112 to retrieve the consumer's information stored in a database 304 of the media application server 112. The database 304 may store events 306 reflecting the consumer's activity as they occur within the system. Events 306 include, for example, content posted by the consumer to a social-media site, changes to the consumer's profile in a social network, establishment of connections to other consumers via social networking, and other actions taken or content provided by the consumer.

In the illustrated embodiment, for convenience of presentation, the media applications described above are provided directly by the single illustrated entity to which the user logs in. In typical implementations, however, no single media application server hosts all of the consumer's media activities. The identity-management server 106 acquires the consumer's non-transactional information by subscribing to various media application servers 112 using well-known approaches, such as really simple syndication (RSS) feeds, API accesses, etc. Other similar subscription technologies supported by the media application server 112 may also be utilized and therefore are within the scope of the current invention. Information from the media application servers 112 may be continuously obtained, or may be obtained periodically, e.g., nightly, using, for example, a web crawler.

In various embodiments, the identity-management server 106 aggregates feeds of information across consumers from the media application servers 112 with which the consumers interact, and stores this information in records corresponding to each consumer in the consumer database 242. In some embodiments, this information is used to update or identify new analysis rules. The consumer's information and records includes transactional and non-transactional data. As noted, both non-transactional and transactional information may be obtained from the consumer's interaction with media applications. But this is not exclusively or even necessarily the case. For example, the identity management server 106 may be maintained by the payment-processing entity that also manages the server 108, which processes payments made by the consumer in the course of purchase transactions. In such implementations, transactional data is obtained and stored on an ongoing basis for each consumer in the database 242, and this data is supplemented by non-transactional data. The non-transactional data, in turn, may be obtained by the identity management server 106 from media application servers 212 as described above, but may also be furnished directly to the server 106 as profile information when the user subscribes to the payment service. For example, the payment service may have consumers sign up on the payment server 108 as participants in a network and obtain profile information as part of the registration process. Such payment networks utilize consumer profile information in identifying prospects for promotions sponsored by merchants that participate in the payment service's transactional network (see, e.g., U.S. Ser. No. 13/901,344, filed on May 23, 2013, the entire disclosure of which is hereby incorporated by reference), to the benefit of the consumers and the merchants.

In any case, transactional data is obtained from previous transactions handled by or informationally accessible to the payment server 108, including purchased items (i.e., goods and/or services), transaction amounts and time, names or merchant category codes of the involved merchants, account numbers, approval or denial information, etc. The non-transactional data is any data not directly derived from previous transactions but relevant to fraud detection. For example, the non-transactional data may include membership status in various organizations (e.g., an animal-rights organization, Sierra Club, Humane Society, National Rifle Association, etc.), a medical history, habits, preferences and dislikes, etc.

Referring again to FIGS. 2B and 3, rules originating with the system designer and/or the rule generator 232 are stored in the rules database 233. In response to a payment request received by the payment server 108, the verification module 230 of the identity management server 106 analyzes the item sought to be purchased against the consumer's transactional and/or non-transactional data in accordance with the analysis rules. In some embodiments, each analysis rule is associated with a numeric score indicating the risk of an invalid transaction if the rule is violated by. The numeric score may not be unitary, but instead may be assigned based on the degree of deviation between the received event or piece of information and the expectation set by the rule. In one embodiment, when the event or information in the requested transaction is consistent with the consumer's expected behavior, the requested transaction is determined to be totally trustworthy and the risk score assigned to the event or information is low (e.g., zero, or in some embodiments, negative); on the other hand, when the requested transaction contains information directly opposed to the consumer's expected behavior, the risk score is defined to be high (for example, one hundred). The rule itself may be associated with a weight so that different rules contribute differently to an overall risk score. For example, allergy risks may be much stronger indicators of consumer behavior than mere subjective preferences, and rules based on allergies may therefore have greater weight. Thus, if the non-transactional data in the consumer's records indicates a peanut or gluten allergy, the rule assessing a purchase against this data may have a high weight—e.g., generator 232 may assign an overall risk score of 90 out of 100 to any purchase involving a peanut or wheat product (the sub-100 score reflecting the possibility that the peanut or wheat product purchase is for others). On the other hand, if the consumer lists himself as an active member in a gymnastics club on a social-media website, any transaction involving fried food (e.g., donuts) may be assigned a risk score of 80—i.e., only somewhat unlikely but possible, and the rule may be associated with a frequency (so that occasional indulgences receive a lower score than binge behavior) and an amount (so that large purchases are more suspect and receive a higher score). In still another example, the consumer's transactional data may indicate that the consumer has not ordered pickles in the past year; a rule may assign a transaction involving pickles a risk score of 20, reflecting the small objective degree of behavioral inconsistency and, in some embodiments, the low price of the pickles. Again, the same type of information may be weighted differently depending on its age and/or the size of the transaction. In some embodiments, more recent information is given greater weight when determining the risk score. For example, a deviation from the consumer's transactional data acquired within the past year may be assigned a risk score of N, whereas a deviation from the transactional data acquired five years ago may be assigned a risk score of N/5. Non-transactional information may also be environmental, e.g., based on the consumer's location and/or the current weather, as well as the current status of the mobile device 102). For example, on a sunny day, the purchase of an umbrella is assigned a risk score of ten, whereas the purchase of an umbrella on a raining day is assigned a risk score of zero. In another example, if the status of the mobile device 102 shows a phone conversation has been ongoing for one hour, a transaction requested during the conversation may be assigned a moderate risk score reflecting the unlikelihood that the user will engage in a purchase transaction during such a long conversation. Similarly, lack of a global-positioning-system (GPS) signal or network connection may have a small associated risk score. But the risk score may be negative, indicating a decreased risk of an invalid transaction, if, for example, the GPS signal transmitted from the mobile device 102 indicates that the consumer is in the location where the transaction is requested. A rule may also have an associated score based on input from the merchant—i.e., the system may permit different merchants in the network to adjust the rule scores to reflect their individual perceptions of risk.

The risk scores obtained by applying all or a subset of the rules in the rules database 233 are totaled by the verification module 230 to arrive at cumulative risk score indicative of the total risk associated with the transaction. In various embodiments, the selection of which rules to apply to a given transaction is determined or adjusted by the sorting module 234. In these embodiments, a consumer's records, including transactional and non-transactional data, current information accessible to the identity-management server 106 during transaction, and/or the merchant input is classified into multiple classes. These classes may be predetermined or may be identified by a conventional learning/training algorithm for classifying data applied to the transactional and non-transactional data. The item(s) sought to be purchased (and/or other attributes of a transaction) are assigned to one or more previously defined classes. The analysis rules may thereby operate at the level of item class rather than at the much more granular item level, and if the class is the meaningful abstraction level for purposes of risk analysis, the rules and the analysis are both simplified i.e., the rule need not specify vast listings of items to which it is applicable. Data related to previous or currently requested transactions is classified into transactional classes; likewise, data unrelated to previous or currently requested transactions is classified into non-transactional classes. Each transactional and non-transactional class may include multiple sub-classes. For example, in a transactional class called “clothing,” there are sub-classes called “apparel,” “accessories,” “lingerie,” etc. The number of classes and sub-classes reflect a trade-off between computational convenience and the accuracy of risk assessment. For example, high-end models or brands of a particular type of good may be much more strongly associated with transactional fraud than lower-priced or less prestigious ones, so sub-classes may be used to reflect these differential risks. Subclasses may also be merchant-defined based on their commercial experience, or may they may be fixed but allow merchants to specify a risk level. Defining risk on a class or subclass level is obviously more convenient for merchants than doing so item-by-item.

Transactional classes may include, for example, type of goods, type of service, dates and time of purchase, etc.; each transactional class is associated with one or more of the analysis rules that specify, for example, pairings of goods or services purchased together in a single transaction, a maximum and a minimum price previously paid by the consumer for a type of goods or services, and/or a duration between successive purchases of items of the same type. For example, in a transactional class of accessories, the transactional history may indicate that the consumer has never spent more than $200 on the accessories. Accordingly, the relevant rule may assign a risk score of one for every dollar above $200 in the requested transaction. Similarly, if data in the grocery class shows that the consumer purchases seafood once per month, a risk score may be assigned based on the number of days remaining before the next expected purchase. For example, if the consumer usually purchases seafood on the first day of every month, but on a particular occasion the consumer purchases the seafood five days early, a risk score of five may be assigned. In another example, when the type of service in the same class has been previously purchased, the risk score may be negative, such as minus ten. The rules generator 232 may define or adjust these rules, and the associated scores, based on the strength and persistence of observed consumer habits. In other words, the rules generator 232 may routinely examine consumer purchases to determine the existence of patterns that can be used for risk analysis, and generate corresponding rules.

The non-transactional classes may include, for example, preference data (such as preferred food or color derived from, for example, postings to a social media site), religious affiliation or membership status in one or more organizations associated with preferences having transactional implications (e.g., membership in a religious organization that shuns alcohol is inconsistent with purchases in a “spirits” goods class, while a PETA member is unlikely to purchase a fur coat), current interactions with the social media site (e.g., announcing the consumer's current status or location on the site), the current GPS location, and the current weather conditions. Preference information can be gleaned from social media sites in an automated fashion, using web crawlers that access social media postings and analyze entries or textual postings for relevant information (see, e.g., U.S. Pat. No. 8,352,406)

Again, each non-transactional class is associated with analysis rules that specify consistency between the currently requested transaction and the information in each class using the principles described above. For example, in the class of current GPS location, a rule may assign an incremental risk value to the requested transaction for every mile between the current GPS location of the consumer and the location of the requested transaction. In another example, the consumer may publish that he has recently converted to vegetarianism on TWITTER, in which case, once again, a rule may assign a risk score of ten to a transaction involving the purchase of meat, Items in each class may be assigned different risk scores and different classes may be weighted differently depending on their perceived value in determining the transaction validity.

In a typical operation, the consumer first presents a payment token stored in the mobile device 102 to the merchant system 110; the payment token may include data identifying the mobile device 102 and/or the consumer's payment instrument (e.g., a credit card, a bank account, or a pre-loaded payment card). The merchant system 110 transmits the payment token together with payment data (e.g., purchased item (a good or a service), amount, and the time and name or merchant category code of the merchant) to the identity-management server 106 (directly or via the payment server 108) to request processing of the transaction. The identity-management server 106 decodes the token using the token payment process 228 and matches the information therein to the consumer's records stored in the database 242 to identify the consumer. The verification module 230 then retrieves analysis rules from the database 233 and determines the likelihood that the requested transaction is valid. The retrieved analysis rules may be the entire set of rules, a subset associated with the identified consumer, or a subset associated with characteristics of the transaction (e.g., the item sought to be purchased). To accomplish the validity assessment, in one embodiment, the verification module 230 transmits information in the received transaction request to the sorting module 232 that, in turn, segregates the information into one or more pieces (or classes). Each piece (or class) of information is assigned a risk score as defined by the retrieved analysis rules. The verification module 230 then adds the risk scores yielded by the rules that were triggered by (i.e., relevant to) the current transactional information to determine a total risk score, which is used to evaluate the likelihood of a fraudulent transaction. For example, if the total risk score is above the first predetermined value (e.g., 100), the transaction is deemed likely to be invalid and therefore is denied. If, however, the total risk score is below the second predetermined value (e.g., 30), the verification module 230 verifies the validity of the transaction and subsequently transmits the requested transaction data to the payment processor 108 for authorization or, in some embodiments, approves the transaction. If the total risk score falls between the two predetermined values, the verification module 230 may interrupt the transaction (i.e., without transmitting the transaction request to the payment processor 108) and request additional verification information (e.g., a personal identification number (PIN) or a password) from the consumer before approving the transaction. In still other embodiments, the risk score is one data point used by a broader risk-analysis or fraud-detection system in evaluating the transaction.

The analysis rules are preferably created prior to the transaction; during the transaction, the verification module 230 can apply the appropriate analysis rules to the information in the requested transaction for expediting the validity verification process. In some embodiments, the analysis rules are created and/or modified during transaction. For example, the identity-management server 106 acquires the consumer's updated information, which is associated with her accounts on the social-media sites, in real-time during transaction; and based thereon, the rule generator 234 may create new rules and/or modify the analysis rules based on the updated information. Because some analysis rules may be created based on the consumer's records, including both transactional and non-transactional data, real-time information and/or merchant inputs and can be easily applied when the identity-management server 106 receives a transaction request, the present invention can reliably detect an unauthorized use of the mobile device tokens and/or payment data encrypted therein, thereby timely preventing a fraudulent transaction.

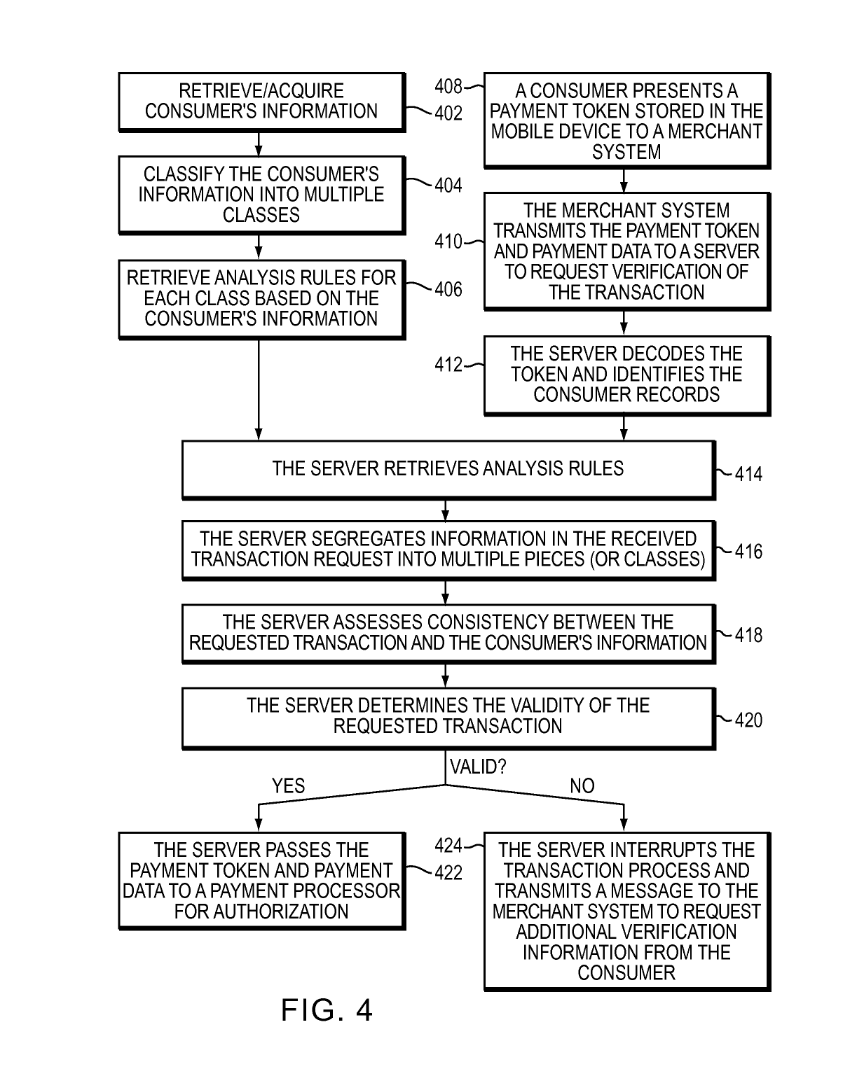

A representative method 400 for determining validity of a transaction payment in accordance with embodiments of the current invention is shown in FIG. 4. Prior to a payment transaction or, in some embodiments, during the payment transaction, information associated with the consumer is retrieved from a consumer database and/or acquired from external sources (e.g., social-medial sites) (step 402). In some embodiments, the consumer's information is classified into multiple classes (step 404). The identity-management server 106 then retrieves analysis rules for each class based on the consumer's information therein (step 406). When the consumer purchases goods or services from a merchant, the consumer initiates a payment transaction by presenting a payment token stored in the mobile device 102 to the merchant system 110 (step 408). The merchant system 110 transmits the payment token and payment data (e.g., purchased item, time, amount, and the name or merchant category code of the merchant) to the identity-management server 106 to request verification of the transaction (step 410). Upon receiving the payment token and data, the identity-management server 106 decodes the token to obtain the information therein and identify the consumer based on the decoded information (step 412). The identity-management server 106 then retrieves analysis rules from the database 233 (step 414). In one embodiment, the identity-management server 106 segregates information in the received payment token and payment data into multiple pieces (or classes) (step 416). The identity-management server 106 then applies the analysis rules to the information to determine consistency between the received information in the current transaction request and the retrieved/acquired transactional and non-transactional data utilizing, for example, risk score assessment (step 418). Based on the determined consistency, the identity-management server 106 evaluates the likelihood that the currently requested transaction has been validly initiated by the consumer (step 420). If the transaction is likely to be valid, the identity-management server 106 passes the payment token and payment data to the payment processor 108 for authorization or, in some embodiments, approves the transaction (step 422). If, however, the transaction is determined to be likely fraudulent, the identity-management server 106 interrupts the transaction process and transmits a message to the merchant system 110 to request additional verification information from the consumer or ultimately denies the transaction (step 424).

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. For example, the approach used to check consistency/conflicts between the received transaction payment and the transactional and non-transactional data stored in the database 242 or obtained from the media application servers 112 may not be unique. Any conventional approach suitable for recognizing consistency/conflict between multiple data sets may be implemented to verify the transaction validity and therefore is within the scope of the current application.

For example, in one embodiment, the sorting module 234 collects all consumer records stored in the database 242 and classifies them into various classes using, for example, a conventional learning/training based algorithm for classifying data. The rule generator 234 then evaluates consistency between the data in each class. Some classes may include data that is not consistent with other classes; in this embodiment, the rule generator 234 labels these classes as opposing classes in accordance with a rule. For example, fur products may be classified as class I and animal protection may be classified as class II; classes I and II are opposing classes. Each consumer therefore may be associated with multiple classes in accordance with his transactional and non-transactional data. When receiving the transaction request, the sorting module 234 may first assign the received transaction data to one or more of the established classes. The verification module 230 then assess transaction validity based on the class(es) associated with the requested transaction data. For example, if one or more classes of the requested transaction are labeled as opposing classes with respect to the classes to which the consumer currently belongs, the verification module 230 may determine that the transaction is likely to be fraudulent. Otherwise, the verification module 230 verifies the validity of the transaction and subsequently transmits the requested transaction data to the payment processor 108 for authorization or, in some embodiments, approves the transaction. In effect, the use of opposing classes is another way of simplifying a rule-based analysis.

In another embodiment, after establishing the classes of the consumers' records, the sorting module 234 groups consumers based on the classes with which they are associated. For example, all consumers listed as members of animal-rights organizations are placed into the same group. The sorting module 234 then collects the transactional data of the consumers within each group and classifies the collected data into various classes. If any of the assigned classes of information in the received transaction request overlap with the classes established based on the previous transactional data of the consumer's group, a rule may assign a negative risk score (i.e., indicating the transaction is likely to be valid). If, however, the received current transactional data is classified into a class that does not overlap with the classes established using the previous transactional data, a positive risk score (i.e., indicating the transaction is more likely to be invalid) may be assigned. For example, the group of consumers having active animal-rights memberships is unlikely to purchase fur products; therefore, the classes determined based on their previous transactional data may not have fur products. If the requested transaction involves a fur coat, the fur coat will not be classified into any class established based on the members' previous transactional data. The fur coat may then have a risk score of, for example, fifty.

In addition, the transaction payment may not be necessarily conducted using a mobile device. Transactions may be initiated using any device (e.g., an automated teller machines (ATM)) and any payment token (e.g., a credit card) presented in person or remotely to the merchant system. More generally, those skilled in the art will readily appreciate that all configurations described herein are meant to be exemplary and that the actual configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “user device,” “mobile,” “communication device,” and similar terminology, refer to a wireless device (e.g., cellular phone, smart phone, computer, PDA, set-top box, Internet Protocol Television (IPTV), electronic gaming device, printer, and so forth) utilized by a user of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The processor 206, 222 that execute commands and instructions may be a general purpose computer, but may utilize any of a wide variety of other technologies including a special purpose computer, a microcomputer, minicomputer, mainframe computer, programmed microprocessor, micro-controller, peripheral integrated circuit element, a CSIC (customer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, code or process) include machine instructions for a programmable processor, and can be implemented in a high-level procedural and/or object-oriented programming language, and/or in assembly/machine language.

The storage devices 240, 244 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the UNIX operating system, the LINUX operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

The storage devices 240, 244 may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described herein. For example, various forms of the flows shown above may be used, with steps re-ordered, added, or removed. Accordingly, other implementations are within the scope of the following claims.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of verifying a payment authorization to complete a current transaction between a consumer and a merchant, the method comprising, at a server:
receiving prior to the transaction, from a consumer device via a network, consumer information and data corresponding to authorization to access consumer non-transactional data stored in a second server;
receiving, from a merchant device, a consumer-originated request for processing the payment to complete the current transaction without secure customer information;
matching received information in the request to records associated with the consumer, thereby identifying the consumer who originated the processing request;
retrieving historical transactional and non-transactional data in records associated with the identified consumer, including consumer non-transactional data obtained from the second server;
computationally determining consistency between the received information in the current transaction and the retrieved transactional and non-transactional data; and
based on the determined consistency, determining a likelihood that the current transaction has been validly initiated by the consumer and processing the transaction if the likelihood exceeds a threshold.

2. The method of claim 1, wherein the consistency-determining step comprises applying at least one analysis rule to at least one of the transactional data and non-transactional data.

3. The method of claim 2, wherein the at least one analysis rule assigns at least one risk score to the current transaction.

4. The method of claim 2, further comprising:
(i) classifying the transactional and non-transactional data into a plurality of classes;
(ii) classifying data in the current transaction into at least one class; and
(iii) based at least in part on the at least one analysis rule, determining consistency between the at least one class of data in the current transaction and the historical data within the plurality of the classes of the transactional and non-transactional data.

5. The method of claim 4, wherein:
(i) the transactional classes include (a) type of goods, (b) type of service, and (c) dates and time of purchase, each transactional class being associated with at least one analysis rule;
(ii) the at least one analysis rule specifies at least one of (a) pairings of goods or services purchased together in a single transaction, (b) a maximum price previously paid by the consumer for a type of goods or services, (c) a minimum price previously paid by the consumer for a type of goods or services, and (d) a duration between successive purchases of items of the same type.

6. The method of claim 4, wherein:
(i) the non-transactional classes include (a) preference data, (b) current interaction with a social-media site, (c) a current GPS location, and (d) current weather conditions, each non-transactional class being associated with at least one analysis rule;
(ii) the at least one analysis rule specifies at least one of (a) consistency between a consumer preference and items purchased in the current transaction, (b) consistency between current interaction with a social-media site and the current transaction, (c) consistency between a current GPS location and the current transaction, and (d) consistency between current weather conditions and the current transaction.

7. The method of claim 2, further comprising:
(i) acquiring, from a second server upon receiving the consumer-originated request, additional records associated with the identified consumer; and
(ii) determining consistency between the additional records and data in the current transaction.

8. The method of claim 7, further comprising, based on the additional records, generating at least one new analysis rule or modifying the at least one analysis rule.

9. The method of claim 1, wherein at least some of the transactional or non-transactional data is derived from a social media account of the consumer.

10. The method of claim 1, further comprising transmitting the processing request to a payment server if the current transaction is determined to be likely valid.

11. The method of claim 1, further comprising interrupting the processing request and requesting additional verification information from the consumer, if the current transaction is determined to be likely invalid.

12. A server for a payment authorization to complete a current transaction between a consumer and a merchant, the server comprising:
a memory comprising a database for storing records associated with the consumer;
a communication module configured for communication over a network; and
a processor configured to:
receive prior to a transaction, from a consumer device via the communication module, consumer information and data corresponding to authorization to access consumer non-transactional data stored in a second server;
receive, from a merchant device, a consumer-originated request for processing the payment to complete the current transaction without secure customer information;
match received information in the request to the records associated with the consumer, thereby identifying the consumer who originated the processing request;
retrieve historical transactional and non-transactional data in records associated with the identified consumer, including consumer non-transactional data obtained from the second server;
computationally determine consistency between the received information in the current transaction and the retrieved transactional and non-transactional data; and
based on the determined consistency, determine a likelihood that the current transaction has been validly initiated by the consumer and process the transaction if the likelihood exceeds a threshold.

13. The server of claim 12, wherein the processor is configured to computationally determine consistency by applying at least one analysis rule to at least one of the transactional data and non-transactional data.

14. The server of claim 13, wherein the at least one analysis rule assigns at least one risk score to the current transaction.

15. The server of claim 13, wherein the processor is further configured to:
(i) classify the transactional and non-transactional data into a plurality of classes;
(ii) classify data in the current transaction into at least one class; and
(iii) based at least in part on the at least one analysis rule, determine consistency between the at least one class of data in the current transaction and the historical data within the plurality of the classes of the transactional and non-transactional data.

16. The server of claim 15, wherein:
(i) the transactional classes include (a) type of goods, (b) type of service, and (c) dates and time of purchase, each transactional class being associated with at least one analysis rule;
(ii) the at least one analysis rule specifies at least one of (a) pairings of goods or services purchased together in a single transaction, (b) a maximum price previously paid by the consumer for a type of goods or services, (c) a minimum price previously paid by the consumer for a type of goods or services, and (d) a duration between successive purchases of items of the same type.

17. The server of claim 15, wherein:
(i) the non-transactional classes include (a) preference data, (b) current interaction with a social-media site, (c) a current GPS location, and (d) current weather conditions, each non-transactional class being associated with at least one analysis rule;
(ii) the at least one analysis rule specifies at least one of (a) consistency between a consumer preference and items purchased in the current transaction, (b) consistency between current interaction with a social-media site and the current transaction, (c) consistency between a current GPS location and the current transaction, and (d) consistency between current weather conditions and the current transaction.

18. The server of claim 13, wherein the processor is further configured to:
(i) acquire, from a second server upon receiving the consumer-originated request, additional records associated with the identified consumer; and
(ii) determine consistency between the additional records and data in the current transaction.

19. The server of claim 18, wherein the processor is further configured to generating at least one new analysis rule or modifying the at least one analysis rule, based on the additional records.

20. The server of claim 12, wherein at least some of the transactional or non-transactional data is derived from a social media account of the consumer.

21. The server of claim 12, wherein the processor is further configured to transmit the processing request to a payment server if the current transaction is determined to be likely valid.

22. The server of claim 12, wherein the processor is further configured to interrupt the processing request and request additional verification information from the consumer, if the current transaction is determined to be likely invalid.
